(19) United States
(12) Patent Application Publication
(10) Pub. No.: US 2024/0392207 A1
(43) Pub. Date: Nov. 28, 2024

(54) A PROCESS FOR REFINING A VEGETABLE OIL

(71) Applicant: INTREFT PTY LTD, Hamilton Hill (AU)

(72) Inventors: Sundar PANDIAN, Hamilton Hill (AU); Ashley PALMER, Hamilton Hill (AU)

(21) Appl. No.: 18/697,867

(22) PCT Filed: Nov. 14, 2022
(86) PCT No.: PCT/AU2022/051359

§ 371 Date: Apr. 2, 2024

(30) Foreign Application Priority Data
Nov. 12, 2021 (AU) 2021903638

(51) Int. Cl. C11B 3/00; A23D 9/04; B01D 3/10; B01D 3/38; C11B 1/10; C11B 3/04; C11B 3/14

(52) U.S. Cl. CPC C11B 3/001; A23D 9/04; B01D 3/10; B01D 3/38; C11B 1/10; C11B 3/04; C11B 3/14

(57) ABSTRACT

A process and apparatus for physically refining a vegetable oil comprising a step of deodourising a crude vegetable oil by steam refining under refining conditions effective to produce a refined vegetable oil having a trans fat content of less than 0.99 wt %. The apparatus may comprise a plurality of volatilisation stages for removal of free fatty acids from a vegetable oil.

### TECHNICAL FIELD

The present invention relates to a process for refining a vegetable oil.

### BACKGROUND ART

The following discussion of the background art is intended to facilitate an understanding of the present invention only. The discussion is not an acknowledgement or admission that any of the material referred to is or was part of the common general knowledge as at the priority date of the application.

The refining of plant oils is complex, either following a physical or chemical refining route with a number of unit operations directed at removal of impurities. Typically, in an initial step, the oil-bearing seed/fruit is pressed or crushed, typically with heating including a so-called expeller process, to maximise oil recovery. The oil is then extracted into petroleum solvent, typically hexane. The petroleum solvent is removed to recover a crude oil. This crude oil, as described in U.S. Pat. No. 5,545,329, typically contains up to 10% of impurities including phospholipids, other fatty acids, organic sulphur compounds, waxes, dye compounds and the like. These impurities have adverse effects on an edible oil—though may have value as a by-product—so removing them to make the oil marketable and useful is a necessity.

Removal of the impurities has made it necessary to use many further processing steps including: degumming, refining, bleaching and deodourising in a chemical refining scheme which uses a range of chemicals and may be expensive. For example, free fatty acids are typically reduced in content through use of an alkaline or caustic refining step in which free fatty acids are converted to soaps that can be removed, with some difficulty, from the oil.

U.S. Pat. No. 6,172,248, the contents of which are hereby incorporated by reference, discloses a chemical refining process, involving admixing of a heated stream of vegetable oil with a dilute aqueous Inorganic or organic acid solution (selected from the group consisting of phosphoric acid, acetic acid, citric acid, tartaric acid, succinic acid and mixtures thereof) following discussion of the disadvantages of alkaline refining such as losses of oil due to emulsification with soapstock, difficulties in soapstock handling and difficulty in disposal of acidic water created in soapstock splitting.

An alternative to chemical refining is physical refining which, though generally applicable to vegetable oils, has mostly been confined to palm oil production. As disclosed in U.S. patent application No. 2014018561, directed to the refining of palm oils, physical refining is an abridged chemical refining route so still involves the use of chemicals and heating during crushing or pressing. Such physical refining is typically a three-stage continuous operation in which incoming crude oil (water degummed crude oil) is treated with acid, in a gum conditioning step and cleansed in a bleaching step with an adsorbent. The oil is then subjected to steam distillation. This process allows for the subsequent deacidification, deodourisation, and removal of carotenoids unique to palm oil. These carotenoids give palm oil its characteristic red colour. Given the lack of a neutralisation step in physical refining, refined bleached oil (RBO) from a physical refinery has nearly the same free fatty acid (FFA) content as found in the crude oil. US 2014018561 seeks to address this issue by bleaching involving heating the oil and cleaning the oil by passing it through adsorptive bleaching clay. Steam distillation for deodourisation follows.

U.S. Pat. No. 5,545,329 discloses a membrane processing route in which an oil is recovered into an organic solvent and treated with a membrane process to remove impurities.

It is an object of the present invention to provide an improved process for refining vegetable oils or at least a useful alternative.

### SUMMARY OF INVENTION

In one aspect, the present invention provides a process for physically refining a vegetable oil comprising a step of deodourising a crude vegetable oil by steam refining under refining conditions effective to produce a refined vegetable oil having a trans-fat content of less than 0.99 wt %.

In another aspect, the present invention provides an apparatus for physically refining a vegetable oil comprising a deodourising vessel for steam refining a crude vegetable oil under refining conditions effective to produce a refined vegetable oil having a trans-fat content of less than 0.99 wt %.

Steam refining, which conveniently involves steam distillation with pressurised stripping steam under vacuum, is preferably conducted under a plurality of controlled conditions selected from the group consisting of vacuum pressure, temperature, stripping steam pressure, fatty acid vapour pressure, crude oil flowrate through steam refining and combinations thereof. The steam refining process is conducted in a manner to minimise generation of trans fats above a level naturally existing in a crude vegetable oil.

The steam distillation is conducted, to remove fatty acids amongst other impurities. Steam distillation is advantageously conducted at a vacuum less than 1.5 torr, preferably less than 1.0 torr and more preferably less than 0.6 torr. Steam distillation is also conducted at a relatively low and advantageously narrow temperature range at temperature less than 240° C., preferably in the range 233-237° C. and most preferably above 225° C., the achievable temperature being correlated with the above described operating parameters, in particular vacuum pressure, steam pressure, steam stripping rate and crude oil flowrate through steam distillation, selected values for each of the parameters also depending on economic constraints relating, amongst other factors, to the construction of the deodourising vessel.

Stripping stream pressure is preferably controlled in the range of 0.8 bar gauge to 3.0 bar gauge, preferably 1 bar gauge to 2.5 bar gauge, and stripping stream volume is also desirably controlled to achieve target fatty acid contents in the refined vegetable oil. Residence time in the distillation vessel is preferably within the range 30 minutes to 120 minutes. All other factors being equal, and with temperature desirably within the above ranges, trans fat content formation is reduced with increased oil flowrate.

The process may comprise further free fatty acid volatilisation steps, prior to steam distillation, selected from the group consisting of flashing and pre-distillation. Such steps allow treatment of higher free fatty acid content crude oils and reduces vapour load in the steam distillation vessel. At the same time, inclusion of such further volatilisation steps may increase oil throughput.

Under such conditions, free fatty acid (FFA) contents in the refined oil may be reduced to less than 0.1 wt %, preferably less than 0.08 wt %, more preferably less than 0.07 wt % and most preferably less than 0.06 wt %. Trans fat formation and so its content in the oil is limited to less than 0.99 wt %, preferably less than 0.8 wt %, more preferably less than 0.7 wt %.

Steam distillation is preferably conducted in a distillation vessel or tower having a plurality of spaced trays, preferably vertically spaced trays such as overflow trays, with conditions at each tray being controlled to achieve said effective conditions. Upstream of the distillation tower may be included further free fatty acid volatilisation process vessels, selected from the group consisting of flashing and pre-distillation vessels. Inclusion of such further process vessel(s) allow treatment of a broader range of free fatty acid content crude oils and reduces, where required, vapour load in the steam distillation vessel. At the same time, inclusion of such further volatilisation steps may increase oil throughput.

The refining process as described herein desirably includes additional steps to deodourisation, notably crude oil extraction, bleaching and degumming. Typically, and in contrast, chemical vegetable oil refining involves the unit operations of degumming, refining, bleaching and deodourising. The process and apparatus of embodiments of the invention involve physical refining. Omitted is a chemical refining step, which would typically involve contacting of oil with chemicals—such as aqueous alkali solution—for the removal of non-hydratable phosphatides, soaps created from the neutralization of free fatty acids and other impurities such as metals. This avoids a soapstock handling problem and reduced losses of oil through saponification. Free fatty acids are primarily removed in the deodourising step which is conducted under temperature, pressure and feed rate conditions effective to limit further formation of trans fats and glycidyl esters.

Oil is preferably extracted while avoiding heating and cooking of the oil which can reduce its quality, for example in terms of trans fat formation. Cold or natural pressing can be used for extraction, using the same expeller process but is conducted in the absence of a solvent and without heating and cooking. A petroleum solvent, such as hexane, should not be used to extract the oil.

Degumming may involve a water degumming process, as understood in the art of vegetable oil refining, which involves admixture of water and organic acid, such as citric acid, with the crude vegetable oil and separating the resulting mixture into an oil component and an oil-insoluble wet gum component, for example using centrifugal separation. Naturally produced organic acid, rather than chemically produced phosphoric acid, is most preferred for degumming.

Following degumming, the refining process desirably includes a bleaching step with an adsorbent prior to deodourising. Conventional adsorbents used in vegetable oil refining, such as aluminosilicates, may be used in the bleaching step.

A further embodiment of the present invention provides a process for physically refining a vegetable oil comprising the steps of:
(a) extracting a crude vegetable oil;
(b) degumming and bleaching the crude vegetable oil for initial removal of impurities; and
(c) deodourising a crude vegetable oil by steam refining under conditions effective to produce a refined vegetable oil having a trans fat content of less than 0.99 wt %.

A still further embodiment of the present invention provides an apparatus for physically refining a vegetable oil comprising:
(a) a presser, desirably operated at ambient conditions, for extracting a crude vegetable oil;
(b) a series of vessels for degumming and bleaching the crude oil for initial removal of impurities; and
(c) a vessel for deodourising a crude vegetable oil by steam refining under conditions effective to produce a refined vegetable oil having a trans-fat content of less than 0.99 wt %.

The deodourising vessel would typically include a steam distillation vessel. Upstream of the distillation tower may be included further free fatty acid volatilisation process vessels, selected from the group consisting of flashing and pre-distillation vessels. Inclusion of such further process vessel(s) allow treatment of a broader range of free fatty acid content crude oils while reducing, where required, vapour load in the steam distillation vessel. At the same time, inclusion of such further volatilisation steps may increase oil throughput.

Vegetable oils which may be refined according to the process include those oils which are more vulnerable to trans fat formation, as indicated for example by their omega-3 fatty acid content in the crude state. Such vegetable oils include-without limitation-canola or rapeseed oil, soybean oil, flaxseed oil, walnut oil, or combinations thereof. Oils with lower omega-3 fatty acid content, and therefore less susceptible to trans fatty acid formation-such as palm oil, cottonseed oil and sunflower oil-would less beneficially be treated with the refining process described in this specification.

Another aspect of the invention provides a refined vegetable oil produced by the above described process and having a trans-fat content less than 0.99 wt %.

Such a refined vegetable oil should not require additives selected from the group of antioxidants and anti-foam agents. Typically, refined oils are treated with antioxidants, such as tert-butyl hydroquinone (TBHQ), and antifoam agents, such as those including silica containing compounds including polysiloxanes. These can be avoided, subject to regulatory requirements, in embodiments of the present invention.

Further, a vegetable oil refined as described above maintains tocopherol content with tocopherol losses being reduced at the lower refining temperatures without a trade off with trans-fat content. By way of example, the process may allow retention of 50-60% of the tocopherols in the crude vegetable oil whereas typical physical refining processes would be expected to retain only 20-30% of tocopherol present in the crude vegetable oil.

An oil produced by the above-described process has a low content of FFAs but also a low content of trans fats. At the same time, through the minimisation or avoidance of use of chemicals during the refining process, the oil has a specification which allows it to be sold as “chemical free” or “numbers free”.

### BRIEF DESCRIPTION OF THE DRAWINGS

Further features of the present invention are more fully described in the following description of several non-limiting embodiments thereof. This description is included solely for the purposes of exemplifying the present invention. It should not be understood as a restriction on the broad summary, disclosure or description of the invention as set out above. The description will be made with reference to the accompanying drawings in which:

FIG. 1 is a: block diagram schematically showing a chemical refining process for refining plant oils according to the prior art.

FIG. 2 is a: block diagram schematically showing a physical refining process for refining plant oils according to the prior art.

FIG. 3 is a: block diagram schematically showing a process for refining plant oils according to one embodiment of the present invention.

FIG. 4 is a detail of an arrangement of process vessels in the deodourisation step according to one embodiment of the present invention.

FIG. 5 is a detail of an arrangement of process vessels in the deodourisation step according to another embodiment of the present invention.

### DESCRIPTION OF PREFERRED EMBODIMENTS

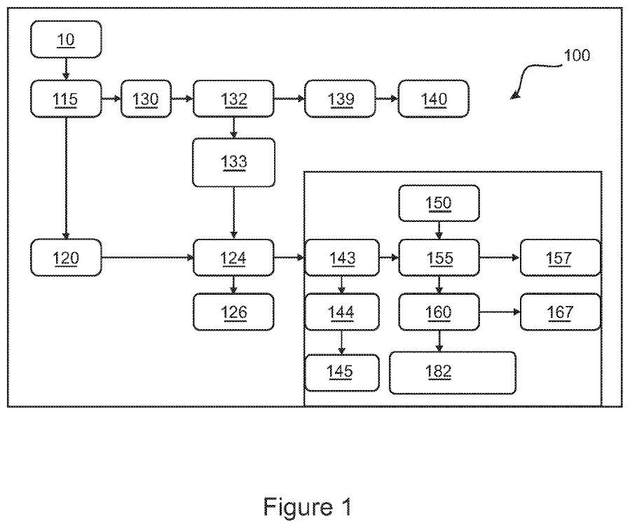

Referring to FIG. 1, a prior art scheme 100 for chemically refining a vegetable oil, such as canola oil, proceeds as follows. Canola oil seeds 10 are crushed in a hot or expeller crushing step 115 at above ambient conditions, for example about 110° C., to produce a crude canola oil 120 and an oil cake 130. Oil cake 130 is contacted with hexane to extract residual oil 133 in extraction step 132. These steps have the benefit of optimised extraction of oil but with the loss of quality due to heating and the addition of hexane which must be removed to produce a deoiled cake or ‘meal’ 139 which can be directed as a feedstock 140, typically for animal consumption.

Crude canola oil 120 contains impurities that must be removed following a somewhat complex series of chemical steps. In step 124, crude canola oil 120 is contacted with water and acid to remove gums. A gum fraction 126 can be separated from an oil fraction which is directed to caustic refining step 143 which involves contacting of oil with a hot solution of caustic soda to form, through saponification, sodium soaps (soapstock) 144 on reaction with fatty acids present in the oil. The saponification process causes an oil loss which, for economic reasons, requires treatment of the soapstock 144 to produce a by-product acid oil 145 by acidulation.

By this stage, the oil fraction has been depleted of a significant proportion of its fatty acid content. The oil fraction is contacted with a bleaching agent 150 in bleaching step 155 to remove colour and other impurities. Typical bleaching agents include aluminosilicates such as neutral earths, acid-activated earths, activated carbon, silicates and mixtures thereof. In bleaching step 155, oil is mixed with an amount of a bleaching agent, heated under vacuum to a bleaching temperature, filtered and directed to deodourisation step 160. Bleaching agent following adsorption, or spent earth 157, is disposed of or possibly regenerated for further use.

Deodourisation step 160 involves contacting of oil with steam in a steam distillation process to remove volatile impurities that reduce quality through odour or poor taste. The deodourisation step 160, conducted under vacuum in a distillation vessel having a number of vertically spaced trays, is intended to deplete the oil of remaining free fatty acids to produce a product oil 182. Distilled fatty acids 167 may have value as a by-product.

As described in U.S. Pat. No. 6,172,248, steam temperature and the time for which the steam contacts the vegetable oil are both important variables directly influencing the types and amounts of volatile impurities that can be removed by steam distillation. Higher temperatures facilitate removal of volatile impurities but also favour reactions that convert less harmful cis fatty acids to trans fatty acids. Lower temperatures reduce the formation of trans fatty acids but at the cost of reducing deodourisation step 160 throughput by requiring longer contact times. This may also indicate a larger and more expensive distillation vessel. Deodourisers, as described in U.S. Pat. No. 6,172,248, may operate at a temperature of 230 to 265° C. and a pressure of about 6 torr, requiring a 45 to 60 minute residence time in the distillation vessel.

Steam requirements for vacuum steam deodourisation step 160 are generally inversely proportional to the vapour pressure of the volatile impurities of the oil at the operating temperature. Thus, for economical operation, deodourisation step 160 is carried out at as high a vacuum as practically possible. Steam vapourises the volatile impurities and carries them away from the oil. U.S. Pat. No. 6,172,248 discloses that, generally, steam in an amount of about 0.5 to about 3.0 percent by weight of oil is required at an operating pressure of about 3 torr. At a higher operating pressure of about 6 torr, steam in an amount of about 2 to about 5 percent by weight of oil is generally required.

The product oil 182 is chemically refined, and though commercially acceptable, depleted of quality due to the heat crushing step 115 and caustic refining step 143. In addition, the product oil 182 contains traces of the chemicals used during its refining and has a trans fatty acid content of about 0.7 wt % in the refined oil. In addition, anti-oxidants and anti-frothing agents must be added to the product oil 182 prior to sale.

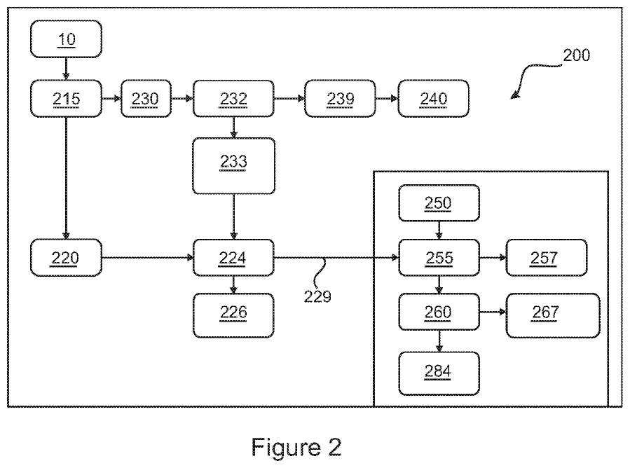

Referring to FIG. 2, a prior art scheme 200 for physically refining a vegetable oil, typically palm oil, proceeds as follows. Steps in common with those in scheme 100 are numbered the same or with the prefix “2” rather than “1”. Prior art scheme 200 follows essentially the same steps as for scheme 100 but the caustic refining step 143 and treatment of the soapstock 144 to produce a by-product acid oil 146 are absent. Deodourisation conditions are essentially the same as described above. Physical refining processes have generally been confined to palm oil processing.

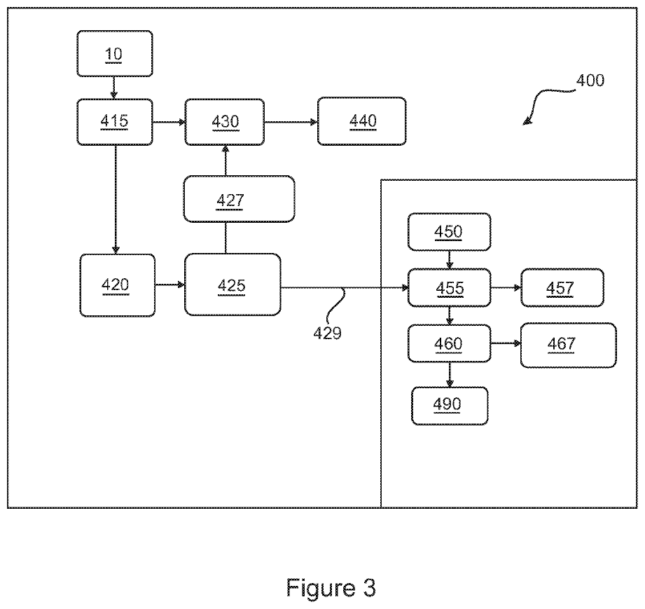

Referring to FIG. 3, a scheme 400 for the physical refining process of a vegetable oil—according to one embodiment of the present invention—proceeds as follows. Steps in common with those in schemes 100 and 200 are numbered the same or with the prefix “4” rather than “1” or “2”.

Canola oil seeds 10 are crushed in crushing step 415 to extract the oil in a cold pressing or natural crush process which does not involve heating of the oil. Rather, pressing is conducted at ambient conditions or even with refrigeration. Oil cake 430 is not contacted with hexane to minimise oil losses prior to directing it as a feedstock 440. This means accepting a certain oil loss but the improved quality of product oil 490 including its very low trans fatty acid content provides value that compensates for oil losses at the front end of scheme 400.

Crude canola oil 420, which contains about 0.2 wt % trans fats, is degummed through a conventional water degumming process, as understood in the art of vegetable oil refining, which involves admixture of water and natural organic acid, preferably natural citric acid, with the crude vegetable oil and separating the resulting mixture into a washed oil 429 and hydrated gums 427, for example using centrifugal separation. The hydrated gums 427 are, in this embodiment, mixed with the oil cake 430.

Bleaching step 455 also proceeds in the manner as above described with bleached oil being directed to steam deodourisation step 460 which differs from the practice as described above in important respects.

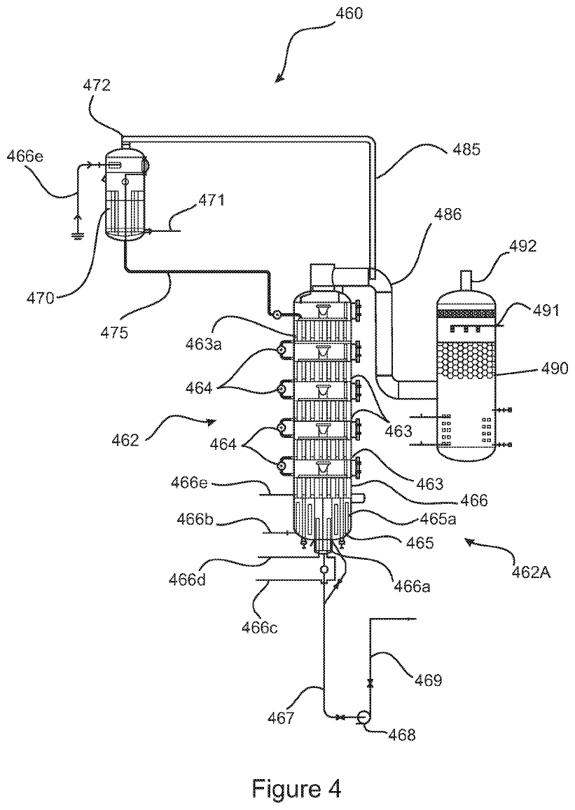

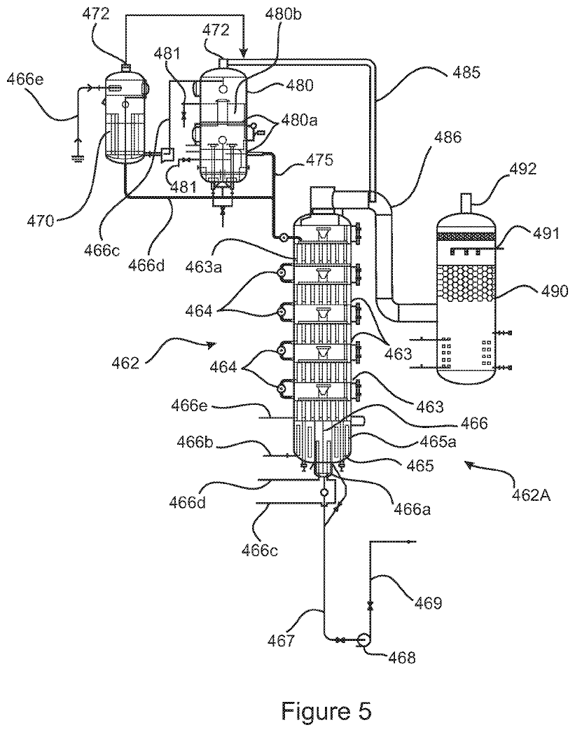

Steam deodourisation step 460 is conducted, as illustrated in FIGS. 4 and 5, in a tower 462, in this embodiment provided with four vertically spaced overflow trays 463, 463a. Tower 462, in contrast to a so-called ‘soft column’, includes no packing and is sized for a residence time between 30 and 120 minutes, in this embodiment 100 minutes, at a desired crude oil flowrate (here 3500 kgs/hr) through the tower 462. Overflow trays 463, 463a have headspace selected to facilitate free fatty acid volatilisation and disengagement from the oil. Preferably, headspace is in the range about 70-80% of tray height. Thus, where tray 463, 463a height is 1150 mm and oil height is 300 mm, headspace is 850 mm.

At each overflow tray 463, steam at required temperature and pressure (1 barg) is directed to strip free fatty acids from the oil. Volatilised fatty acids are directed through duct 486 extending from the top of tower 462 to the vapour handling system, here scrubber 490 which operates as described below.

The bottom 462A of tower 462 comprises an outer shell 465 and an inner shell 466, both of which contain indirect heaters in the form of a set of immersion coils 465a and 466a. Bleached oil 466c from bleaching step 455 is directed to inner shell 466 where it is heated, for example about 30° C., by deodourised oil 467 flowing through immersion coil 466a. The heated bleached oil 466d is then directed to deaerator (not shown). The deaerator removes air prior to re-direction of oil 466b back to the bottom of tower 462. The presence of air in the oil would interfere with downstream heating processes as described further below.

Outer shell 465 of bottom 462A of tower 462 has a set of immersion coils 465a which heats oil 466b from the deaerator to a temperature (T₁) significantly lower than the distillation temperature, in this case T₁=190° C., through heat exchange with oil 468 flowing from the bottom tray of the tower 462 (and through the immersion coils 465a). The heated oil 466e is then directed to thermic fluid heaters (not shown)—which operate for example by indirect heat exchange with a thermic fluid such as an oil—for heating to target distillation temperature (<240° C.) prior to delivery, through line 475 to top tray (tray 1) 463a of tower 462 for distillation treatment for removal of free fatty acids, while minimising trans-fat formation under the conditions described in this specification.

Following oil refining in distillation tower 462, refined oil 467 is pumped from the bottom of distillation tower 462 by pump 468 through line 469 to cooling and storage.

It will be appreciated that there is a temperature profile over the trays 463 of tower 462, the lowest temperature being at the bottom tray and the highest at the top tray 463a with about a 5° C. difference between the two.

Prior to direction to tower 462, heated oil 463—at distillation target temperature below 240° C. as measured at the inlet to splasher 470 described below—is conveniently directed to a vacuum flasher or splasher 470 maintained under high vacuum (for example 0.5-1.0 Torr). Stripping steam may be supplied to splasher 470 through line 471 at 1 barg pressure. Line 466e delivers oil to splasher 470 at an expander arranged at an angle. This allows flashing off of 50-60% of free fatty acids with the object of reducing vapour load in upstream equipment, notably tower 462, and increasing oil throughput capacity. Flashed fatty acids are drawn by vacuum through port 472 and vapour line 485 and duct 486 to the scrubber 490 of the deodourisation stage. Temperature drop in the splasher 470 may, in some cases, be sufficient to drop oil temperature a few degrees, say 5° C., to a temperature below target distillation temperature. In such case, a thermic heater or immersion coil—for example operating as described above—may be included in either or both of the splasher 470 and pre-distiller 480 (as described below) to reheat the oil to the target distillation temperature.

Scrubber 490 is a packed tower configured to collect and condense fatty acid vapours volatilised in deodourisation step 460 and delivered to scrubber 490 by duct 486. The fatty acids are condensed by cooling with a recirculating stream of liquid fatty acid containing condensate through sprayer 491. A scrubbed vapour stream is directed through line 492 to further treatment for removal of components vapourised during deodourisation as known in the art of vegetable oil refining.

The advantages of the scheme 400 and deodourisation system 460 as above described are emphasised by the following examples.

### Example 1

Deodourisation step 460 for a first canola oil, treated in the flowsheet of FIG. 3, is conducted at low temperature and vacuum with low trans fats (all under 1%) and fatty acid contents as shown by the following example for a 25 hour steam distillation run involving control over deodorisation temperature, stripping steam pressure, vacuum pressure and flowrate at distillation tower 462:

| Average | Time from | Total Trans | Free Fatty | Stripping | Vacuum | |
|---|---|---|---|---|---|---|
| Temperature | Run Start | Fat | Acids | Steam | Pressure | Flow Rate |
| (C.) | (hrs) | (wt %) | (wt %) | (Bar gauge) | (torr) | (tph) |
| 236 | 0 | 0.99 | 0.053 | 1 | 1 | 3.4 |
| 236 | 1 | 0.69 | 0.065 | 1 | 1 | 3.5 |
| 234 | 2 | 0.90 | 0.063 | 1 | 1 | 3.4 |
| 234 | 3 | 0.87 | 0.076 | 1 | 1 | 3.5 |
| 235 | 5 | 0.78 | 0.100 | 1.5 | 1 | 3.5 |
| 235 | 6 | 0.79 | 0.097 | 1.5 | 0.5 | 3.5 |
| 236 | 16 | 0.78 | 0.081 | 1.4 | 0.6 | 3.5 |
| 236 | 20 | 0.79 | 0.063 | 1.5 | 1 | 3.4 |
| 236 | 22 | 0.76 | 0.074 | 1.5 | 1 | 3.4 |
| 236 | 25 | 0.74 | 0.069 | 1.5 | 1 | 3.4 |

### Example 2

A deodourisation step 460 for a second canola oil, treated in the flowsheet of FIG. 3, was conducted over a temperature range and vacuum resulting in low trans fats (all under 1%) and free fatty acid (FFA) contents. Treatment of the canola oil was conducted for a 24 hour continuous run with stripping stream pressure being held constant at 1.5 bar gauge and flowrate being held constant at 2600 kg/hour. The run started with highest temperature 248° C. with temperature being lowered every three hours in the order 248° C., 245° C., 240° C., 238° C., 236° C. and 235° C. Once temperature reached 235° C., this was maintained for the rest of the run which completed after 24 hours. At every set temperature, three samples were collected at hourly intervals and the average result for the three samples was obtained as provided in the table below:

| Processing Temperature | Free Fatty Acid (FFA) | |
|---|---|---|
| (° C.) | Content (wt %) | Trans Fats (wt %) |
| 235 | 0.098 | 0.78 |
| 236 | 0.071 | 0.79 |
| 238 | 0.065 | 0.89 |
| 240 | 0.046 | 1.2 |
| 245 | 0.042 | 1.27 |
| 248 | 0.06 | 1.31 |

Trans fat content was limited to 0.78 wt % and FFA was 0.098 wt % in the product canola oil.

### Example 3

A deodourisation step 460 for a second canola oil, treated in the flowsheet of FIG. 3, was conducted over a temperature range and vacuum resulting in low trans fats (all under 1%) and free fatty acid (FFA) contents. Treatment of the canola oil was conducted for a 24 hour continuous run with stripping stream pressure being held constant at 1.5 bar gauge and flowrate being held constant at 3500 kg/hour. The run started with highest temperature 248° C. with average temperature over the steam distillation tower being lowered every three hours in the order 248° C., 245° C., 240° C., 238° C., 236° C. and 235° C. Once temperature reached 235° C., this was maintained for the rest of the run which completed after 24 hours. At every set temperature, three samples were collected at hourly intervals and the average result for the three samples was obtained as provided in the table below:

| Processing Temperature | Free Fatty Acid (FFA) | |
|---|---|---|
| (° C.) | Content (wt %) | Trans Fats (wt %) |
| 248 | 0.046 | 1.24 |
| 245 | 0.073 | 1.23 |
| 240 | 0.083 | 1.1 |
| 238 | 0.072 | 0.85 |
| 236 | 0.072 | 0.76 |
| 235 | 0.073 | 0.73 |

In the above example, trans fat formation could be limited to 0.73 wt % to 0.085 wt % trans fats and 0.072-0.073 wt % FFA in the product canola oil.

### Example 4

A deodourisation step 460 for a second canola oil, treated in the flowsheet of FIG. 3, was conducted over a seven day period resulting in low trans fats (all under 1%) and free fatty acid (FFA) contents. Refined canola oil composition and other process data is also included in the following Tables:

| | | | Free fatty | | | | |
|---|---|---|---|---|---|---|---|
| | Free Fatty | | Acid (FFA) | | | | |
| | Acid Content | | Content | | AVG | Sparging | |
| | of Crude | Total Trans | of Refined | Average | process | Steam | Flow rate |
| | canola oil | Fat | Canola oil | Vacuum | Temp | pressure | (Tonne |
| Day | (wt %) | (wt %) | (wt %) | (Torr) | (° C.) | (barg) | per day) |
| RUN 1 | | | | | | | |
| 1 | 0.51 | 0.95 | 0.055 | 1.4 | 237.1 | 2.4 | 65 |
| 2 | 0.42 | 0.61 | 0.086 | 1.5 | 231 | 2.4 | 65 |
| 3 | 0.4 | 0.66 | 0.083 | 1.5 | 230.9 | 2.4 | 65 |
| 1 | 0.34 | 0.66 | 0.070 | 1.6 | 230.9 | 2.4 | 65 |
| 5 | 0.42 | 0.74 | 0.073 | 1.6 | 231.2 | 2.4 | 65 |
| 6 | 0.42 | 0.90 | 0.071 | 1.5 | 238.0 | 2.4 | 67 |
| RUN 2 | | | | | | | |
| 1 | 0.34 | 0.91 | 0.063 | 1.0 | 238.0 | 1.0 | 69.60 |
| 2 | 0.35 | 0.96 | 0.055 | 0.8 | 238.6 | 1.0 | 66.00 |
| 3 | 0.34 | 0.96 | 0.049 | 0.7 | 238.2 | 1.0 | 64.80 |
| 4 | 0.34 | 0.95 | 0.053 | 0.7 | 236.9 | 1.0 | 62.40 |
| 5 | 0.45 | 0.79 | 0.053 | 0.6 | 235.0 | 1.0 | 60.00 |
| 6 | 0.40 | 0.77 | 0.050 | 0.7 | 235.0 | 1.0 | 55.00 |

| | Palmitic | Stearic | Oleic | Linoleic | Linolenic | Erucic | | Saponi- |
|---|---|---|---|---|---|---|---|---|
| | acid | acid | acid | acid | acid | acid | Iodine | fication |
| Day | (C16:0) | (C18:0) | (C18:1) | (C18:2) | (C18:3) | (C22:1) | value | Value |
| RUN 1 | | | | | | | | |
| 1 | 4.76 | 2.04 | 61.88 | 19.39 | 8.94 | 0.01 | 112.7 | 191.0 |
| 2 | 5.23 | 2.01 | 61.50 | 19.73 | 9.31 | 0.01 | 113.2 | 191.3 |
| 3 | 4.77 | 1.92 | 60.40 | 20.23 | 9.86 | 0.01 | 114.5 | 191.1 |
| 4 | 5.36 | 1.84 | 60.37 | 20.09 | 10.12 | 0.01 | 115.1 | 191.3 |
| 5 | 5.09 | 1.93 | 61.53 | 18.95 | 10.01 | 0.01 | 114.0 | 191.3 |
| 6 | 4.86 | 1.92 | 61.40 | 19.32 | 9.91 | 0.01 | 114.7 | 191.2 |
| RUN 2 | | | | | | | | |
| 1 | 5.36 | 1.81 | 60.74 | 19.69 | 9.97 | 0.00 | 115.0 | 191.4 |
| 2 | 5.25 | 1.84 | 60.73 | 19.63 | 10.00 | 0.01 | 115.1 | 191.4 |
| 3 | 5.91 | 1.81 | 60.46 | 19.49 | 9.75 | 0.01 | 114.0 | 191.5 |
| 4 | 5.94 | 1.85 | 60.35 | 19.53 | 9.75 | 0.01 | 113.9 | 191.5 |
| 5 | 5.74 | 1.83 | 60.34 | 19.66 | 9.97 | 0.01 | 114.3 | 191.6 |
| 6 | 5.88 | 1.87 | 60.46 | 19.57 | 9.84 | 0.00 | 113.9 | 191.5 |

Although the examples above are for canola oil, similar results would be expected, following a deodourisation step 460, for a soybean oil. Crude canola oil typically contains a relatively high proportion of omega-3 fatty acids, a precursor to trans fatty acids, for example about 11 wt % omega-3 fatty acids. Crude soybean oil contains less omega-3 fatty acids, for example about 7 wt % omega-3 fatty acids and thus a trans fatty acid content of about 0.5 wt % could be achieved for soybean oil refined as described with reference to FIG. 3 and the above example. This compares with a commercial soybean oil sample which contained 0.9 wt % trans fats and indicating a process of chemical refining under conditions unlike those described above.

In another embodiment, as shown in FIG. 5, deodourisation system 460, includes a pre-distiller 480 in addition to the flasher (splasher) 470. As with flasher 470, the pre-distiller 480 is included to reduce vapour load in the tower 462 (particularly for oils which, in crude state, contain high input free fatty acids (FFA), say >0.5 wt % FFA and is expected to significantly assist to increase oil throughput capacity, potentially from 85 tpd to 150 tpd oil throughput. Pre-distiller 480 operates on the same principle as distillation tower 462 and may also be considered a secondary distiller. Steam for stripping free fatty acids from the oil is supplied through steam line 481.

The pre-distiller 480—which is also provided with plural trays, in this case two vertically spaced trays 480a, the upper tray 480b of which is supplied with oil from line 466c from splasher 470 at target distillation temperature (<240° C.). A steam pump may be used to drive oil from the splasher 470 into the upper tray 480b of pre-distiller 480. Line 466d is a drain line which would typically be used when plant stoppages for maintenance are required.

From the upper tray 480a of upper compartment 480b, oil overflows downward under influence of gravity to the lower tray 480a with free fatty acids being volatilised during this process. Trays 480a are advantageously be configured with more head space 480b (for example 1150 mm for the upper tray 480a and 900 mm for the tray 480a below it) than available for the trays 463, 463a in distillation tower 462 which allows fatty acid vapours to be driven off, through vapour line 485 and vapour duct 486 to scrubber 490, more effectively even than in distillation tower 462. Oil is directed through line 462a to top tray 463a of distillation tower 462. Stripping steam is delivered to pre-distiller 480 through lines 481. Operating conditions for pre-distiller 480—which is also operated under vacuum—include 0.5-1.0 Torr absolute pressure, 235-240° C. temperature—and an exemplary stripping steam pressure of 1 barg, comparable with those for distillation tower 462.

Thus, the combination of distillation tower 462, splasher 470 and pre-distiller 480 in the deodourisation of vegetable oil—which forms a further aspect of the present invention—may be operated to increase the overall efficiency of the vegetable oil refining process as compared to using a distillation tower 462 alone.

Although step 460 has been described in this specification as a deodourisation step, it has the primary duty in process scheme 400 of free fatty acid removal while minimising trans fat formation, a duty that is shared in chemical refining processes with the chemical refining steps. Such processes may be more economic because lower distillation tower temperatures can be used. However, the product oil contains residues from the chemical refining steps and the Applicant has sought to develop a process which avoids such residues, lowers trans fat and free fatty acid levels and which may be attractive to a segment of the vegetable oil market.

Modifications and variations to the process of refining a vegetable oil as described in this specification may be apparent to those skilled in the art. Such modifications and variations are deemed within the scope of the present invention.

Throughout this specification, unless the context requires otherwise, the word “comprise” or variations such as “comprises” or “comprising”, will be understood to imply the inclusion of a stated integer or group of integers but not the exclusion of any other integer or group of integers.

1. A process for physically refining a vegetable oil comprising:
(a) extracting a crude vegetable oil;
(b) degumming and bleaching the crude vegetable oil for initial removal of impurities; and
(c) deodourising the crude vegetable oil by steam distillation in a deodourising vessel under refining conditions effective to remove fatty acids present in the crude vegetable oil without neutralisation and saponification
wherein said deodourising vessel is a tray tower comprising a plurality of vertically spaced trays with temperature and pressure conditions at each tray being controlled to achieve said effective refining conditions such that vegetable oil flowing through an outlet of said tray tower is a refined vegetable oil having a trans fat content of less than 0.99 wt %.

2-32. (canceled)

33. The process of claim 1, wherein said steam distillation is conducted with pressurised stripping steam under vacuum and is conducted under a plurality of controlled conditions selected from the group consisting of vacuum pressure, temperature, stripping stream pressure, fatty acid vapour pressure, crude oil flowrate through steam distillation, residence time and combinations thereof.

34. The process of claim 33, wherein steam distillation temperature is less than 240° C. and steam distillation is conducted at a vacuum less than 1.5 torr.

35. The process of claim 34, wherein steam distillation temperature is in the range 233-237° C.

36. The process of claim 34, wherein steam distillation temperature is above 225° C.

37. The process of claim 34, wherein pressure during steam distillation is less than 1.5 torr.

38. The process of claim 37, wherein vacuum is less than 1.0 torr.

39. The process of claim 38, wherein vacuum is less than 0.6 torr.

40. The process of claim 33, comprising at least one further free fatty acid volatilisation step(s), prior to steam distillation, selected from the group consisting of flashing and pre-distillation.

41. The process of claim 33, wherein free fatty acids in the refined oil are reduced to less than 0.1 wt %.

42. The process of claim 33, wherein trans fat content in the refined oil is less than 0.8 wt %, more preferably less than 0.7 wt % and most preferably less than 0.6 wt %.

43. The process of claim 33, wherein stripping steam pressure is in the range 1 bar gauge to 3.0 bar gauge, preferably 1 bar gauge to 2.5 bar gauge.

44. The process of claim 33, wherein residence time in the steam distillation tower is within the range 30 minutes to 120 minutes.

45. The process of claim 33, comprising the step of extracting said crude vegetable oil in the absence of a solvent.

46. The process of claim 34, wherein said crude vegetable oil is degummed with an admixture of water and citric acid.

47. An apparatus for physically refining a vegetable oil comprising:
(a) an extraction stage for extracting a crude vegetable oil;
(b) a degumming stage and a bleaching stage for initial removal of impurities; and
(c) a deodourising vessel for deodourising a crude vegetable oil by steam distillation under refining conditions effective to remove fatty acids present in the crude vegetable oil without neutralisation and saponification
wherein said deodourising vessel is a tray tower comprising a plurality of vertically spaced trays with conditions at each tray being controlled to achieve said effective refining conditions such that vegetable oil flowing through an outlet of said tray tower is a refined vegetable oil having a trans fat content of less than 0.99 wt %.

48. The apparatus of claim 47, wherein said steam distillation tower is operated under a plurality of controlled conditions selected from the group consisting of vacuum pressure, temperature, stripping stream pressure, fatty acid vapour pressure, crude oil flowrate through steam distillation, residence time and combinations thereof.

49. The apparatus of claim 48, wherein steam distillation temperature is less than 240° C. and steam distillation is conducted at a vacuum less than 1.5 torr.

50. The apparatus of claim 48, wherein steam distillation temperature is in the range 233-237° C.

51. The apparatus of claim 48, wherein steam distillation temperature is above 225° C.

52. The apparatus of claim 51, wherein vacuum during steam distillation is less than 1.5 torr.

53. The apparatus of claim 52, wherein vacuum is less than 1.0 torr.

54. The apparatus of claim 53, wherein vacuum is less than 0.6 torr.

55. The apparatus of claim 48, comprising, upstream of the steam distillation tower at least one further free fatty acid volatilisation process vessel selected from the group consisting of flashing and pre-distillation vessels.

56. The apparatus of claim 48, comprising:
(a) a presser comprising said extraction stage for extracting a crude vegetable oil in the absence of a solvent; and
(b) a series of vessels comprising said degumming and bleaching stages for degumming and bleaching the crude vegetable oil for initial removal of impurities prior to said steam distillation tray tower.
